(19) United States
(12) Patent Application Publication
(10) Pub. No.: US 2008/0220753 A1
(43) Pub. Date: Sep. 11, 2008

(54) MOBILE COMMUNICATION DEVICE, COMMUNICATION SYSTEM AND COMMUNICATION METHOD

(75) Inventor: Munehito MATSUDA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/044,599

(22) Filed: Mar. 7, 2008

(30) Foreign Application Priority Data
Mar. 8, 2007 (JP) 2007-058762

(51) Int. Cl. H04M 3/42; H04B 1/38

(52) U.S. Cl. 455/416; 455/566

(57) ABSTRACT

A mobile communication device for performing communications with a plurality of mobile communication devices via a server storing audio data transmitted from the mobile communication devices and display information associated with the audio data. The mobile communication device includes: a display information requesting unit operable to request a set of display information to the server; a display information receiving unit operable to receive the requested display information from the server; and a display unit operable to display the received display information.

### CROSS REFERENCE TO RELATED APPLICATIONS

This application is based upon and claims priority of Japanese Patent Application No. 2007-058762, the contents of which are incorporated herein by reference.

### BACKGROUND OF THE INVENTION

(1) Field of the Invention

The present invention relates to a technology for allowing a plurality of users to perform communications therebetween via a server in a mobile communication system.

(2) Description of the Related Art

Conventionally known is the group communication which is a technology for allowing a plurality of users in a group to perform audio communications therebetween. For example, a document discloses a communication system in which a plurality of users can perform audio communications therebetween via a packet-switched network by using VoIP (Voice over Internet Protocol).

In the following description, a group communication performed through audio interaction is referred to as “audio group communication”.

In the audio group communication, a server provided in a network manages each group which is composed of a plurality of users, and controls communications between users. For example, the server serves as an intermediary in transferring audio data. Each user uses a mobile communication device of his/her own to have conversations with other users via the server.

Meanwhile, while such an audio group communication is being performed by a plurality of users, another user may enter the communication in the middle thereof.

In such a case, the newly entered user would hesitate to join the conversation since the user is not acquainted with the subject that has been discussed among the users in the conversation. This is considered as one problem of the audio group communication.

Also, while an audio group communication is being performed by a plurality of users, a user among those may have to go out of the communication for some reason, for example, to get another job done. In this case also, the user would lose the subject of the conversation while he/she goes out of the conversation, and this would also make the user difficult to join the conversation.

### SUMMARY OF THE INVENTION

According to one aspect of the present invention, there is provided a mobile communication device for performing communications with a plurality of mobile communication devices via a server storing audio data transmitted from the plurality of mobile communication devices and display information associated with the audio data, the mobile communication device comprising: a display information requesting unit operable to request a set of display information to the server; a display information receiving unit operable to receive the requested display information from the server; and a display unit operable to display the received display information.

According to another aspect of the present invention, there is provided a communication system comprising a server and a plurality of mobile communication devices which perform communications with each other via the server, the server including: an audio data storage unit operable to store audio data transmitted from the plurality of mobile communication devices; a display information storage unit operable to store display information in association with the audio data; and a display information transmitting unit operable to transmit the display information to the plurality of mobile communication devices, in accordance with requests received from the plurality of mobile communication devices, and each of the plurality of mobile communication devices includes: a display information requesting unit operable to request the display information to the server; a display information receiving unit operable to receive the requested display information from the server; and a display unit operable to display the received display information.

According to still another aspect of the present invention, there is provided a communication method for a mobile communication device for performing communications with a plurality of mobile communication devices via a server storing audio data transmitted from the plurality of mobile communication devices and display information associated with the audio data, the communication method comprising the steps of: requesting a set of display information to the server; receiving the requested display information from the server; and displaying the received display information.

It should be noted here that the display information is information displayed to visually convey contents of audio statements to the users, and is, for example, text data generated from audio using a voice recognition technology.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 illustrates the structure of the communication system 10;

FIG. 2 is a block diagram showing the structure of the mobile communication device 100;

FIG. 3 is a block diagram showing the structure of the server 400;

FIG. 4 illustrates the data structure of data stored in the server 400;

FIGS. 5A and 5B are flowcharts showing basic operations of the server 400;

FIG. 6 is a sequence diagram showing the operation of the mobile communication device 100 and the server 400 in Embodiment 1;

FIGS. 7A and 7B show examples of a screen displayed on the display unit 103;

FIG. 8 is a sequence diagram showing the operation of the mobile communication device 100 and the server 400 in Embodiment 2;

FIG. 9 is a sequence diagram showing the operation of the mobile communication device 100 and the server 400 in Embodiment 3; and

FIG. 10 is a sequence diagram showing the operation of the mobile communication device 100 and the server 400 in Embodiment 4.

### DESCRIPTION OF THE PREFERRED EMBODIMENTS

The following describes preferred embodiments of the present invention with reference to the attached drawings.

### Embodiment 1

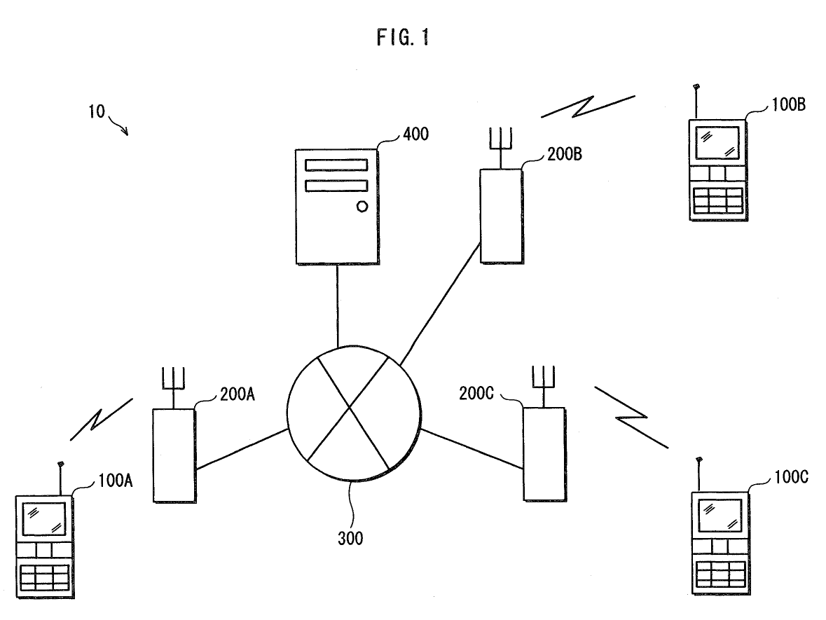

First, a communication system and a mobile communication device in the first embodiment will be described with reference to FIGS. 1-3.

1. Structure

1-1. System Structure

FIG. 1 illustrates a communication system 10 for achieving the audio group communication.

As shown in FIG. 1, the communication system 10 includes a plurality of mobile communication devices 100A through 100C, base stations 200A through 200C, a network 300, and a server 400.

Each of the mobile communication devices 100A through 100C is a communication device that can perform an audio group communication, and is connected to the network 300 via the base stations 200A through 200C.

The server 400 is a server for performing a user management and a communication management for achieving the audio group communication, and is connected to the network 300 as is the case with the mobile communication devices 100A through 100C.

In this way, the mobile communication devices 100A through 100C are connected to the server 400 via the network 300, and are structured such that the mobile communication devices 101A through 100C can perform the audio group communication with each other via the server 400.

In the present document, it is presumed that the mobile communication devices 100A through 100C have the same structure, and thus in the following description, the mobile communication devices 100A through 100C may be called generically as a mobile communication device 100.

Similarly, it is presumed that the base stations 200A through 200C have the same structure, and thus in the following description, the base stations 200A through 200C may be called generically as a base stations 200.

1-2. Structure of Mobile Communication Device

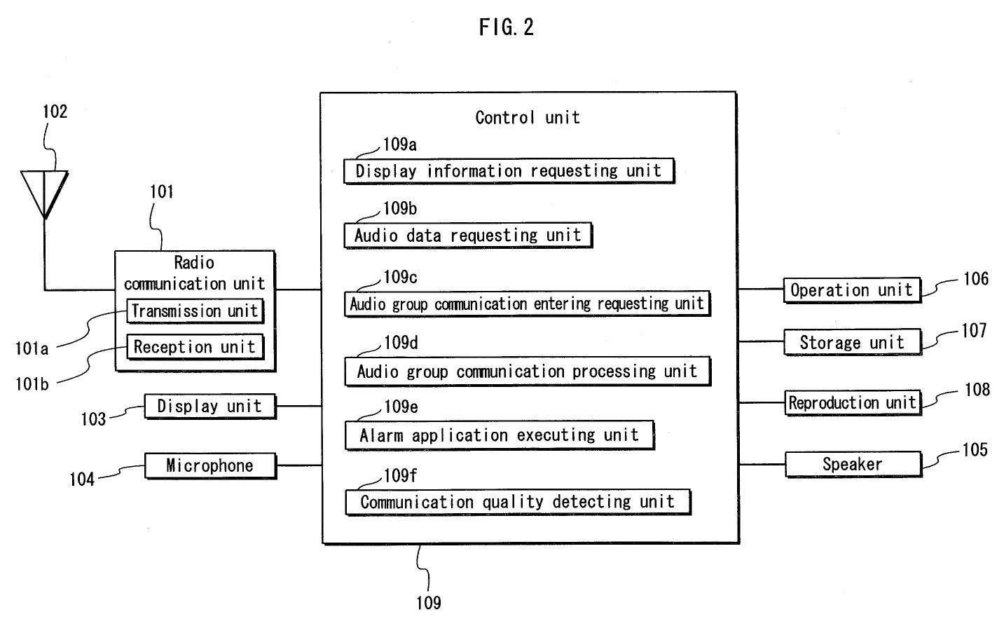

FIG. 2 is a block diagram showing the structure of the mobile communication device 100.

As shown in FIG. 2, the mobile communication device 100 includes a radio communication unit 101, an antenna 102, a display unit 103, a microphone 104, a speaker 105, an operation unit 106, a storage unit 107, a reproduction unit 108, and a control unit 109.

The radio communication unit 101 is a communication unit with which the mobile communication device 100 performs a communication with the base station 200. The radio communication unit 101 includes a transmission unit 101a and a reception unit 101b. The transmission unit 101a modulates the data to be transmitted and outputs the modulation result via the antenna 102. The reception unit 101b obtains data by demodulating a signal received via the antenna 102.

The display unit 103 is, for example, a display device composed of an LCD (Liquid Crystal Display), and displays various types of information that are necessary for using the mobile communication device 100.

The microphone 104 collects sounds and converts the collected sounds into audio signals. For example, the microphone 104 collects voices uttered by the user of the mobile communication device 100 when the mobile communication device 100 performs an audio group communication with other communication devices.

The speaker 105 converts audio signals into sounds/voices and outputs the sounds/voices outwards. For example, the speaker 105 outputs voices uttered by a partner onto his/her own communication device during an audio group communication, sounds/voices of audio data received by the reception unit 101b, sounds/voices reproduced by the reproduction unit 108, and an alarm sound.

The operation unit 106 is composed of, for example, a group of keys that can be pressed by the user for inputting data or instructions. For example, the operation unit 106 can receive: a user's request for entering an audio group communication; a user's request for leaving an audio group communication; and a user's request to talk to other participants during an audio group communication.

The storage unit 107 is achieved by a memory such as RAM (Random Access Memory), and stores information necessary for various processes performed by the mobile communication device 100. For example, the storage unit 107 stores an IP address of the server 400 and text data and audio data that are received by the reception unit 101b from the server 400.

The reproduction unit 108 performs reproduction by decoding the audio data and outputting the decoded audio data to the speaker 105.

The control unit 109 controls the units 101 to 108, and is achieved by, for example, a CPU (Central Processing Unit). The control unit 109 includes a display information requesting unit 109a, an audio data requesting unit 109b, an audio group communication entering requesting unit 109c, an audio group communication processing unit 109d, an alarm application executing unit 109e, and a communication quality detecting unit 109f. It should be noted here that the units included in the control unit 109 are represented by computer programs.

The display information requesting unit 109a generates a request signal that requests, to the server 400, text data (which will be described later) that is stored in the server 400, and outputs the request signal to the transmission unit 101a.

The audio data requesting unit 109b generates a request signal that requests, to the server 400, audio data (which will be described later) that is stored in the server 400, and outputs the request signal to the transmission unit 101a.

The audio group communication entering requesting unit 109c generates a request signal that indicates a request, to the server 400, of the user to enter an audio group communication, and outputs the request signal to the transmission unit 101a, and also generates a request signal that indicates a request, to the server 400, of the user to leave an audio group communication while it is performed, and outputs the request signal to the transmission unit 101a.

The audio group communication processing unit 109d performs a communication process for performing an audio group communication. Especially, when receiving a corresponding operation of the user onto the operation unit 106, the audio group communication processing unit 109d generates a request signal that indicates a request to talk to other participants during an audio group communication, and outputs the request signal to the transmission unit 101a.

The alarm application executing unit 109e executes an application for outputting an alarm sound.

The communication quality detecting unit 109f detects a communication quality of a communication performed between the radio communication unit 101 and the base station 200. For example, the communication quality detecting unit 109f measures an RSSI (Received Signal Strength Indicator) value, judges whether or not the measured RSSI value is less than a predetermined level, and determines the communication quality in accordance with the judgment result.

1-3. Structure of Server

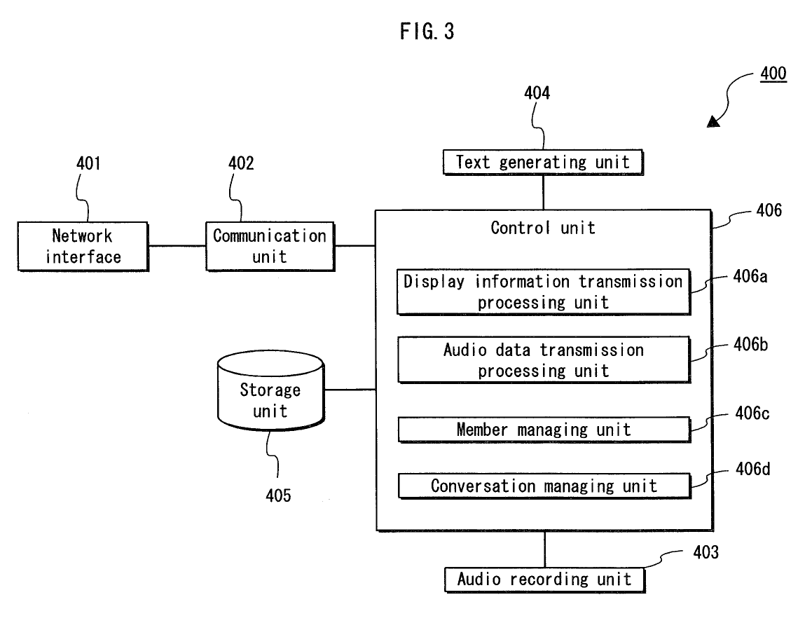

FIG. 3 is a block diagram showing the structure of the server 400.

As shown in FIG. 3, the server 400 includes a network interface 401, a communication unit 402, an audio recording unit 403, a text generating unit 404, a storage unit 405, and a control unit 406.

The network interface 401 connects the server 400 with the network 300 by a wired connection, and is in compliance with, for example, Ethernet™ standard.

The communication unit 402 encodes data that is to be transmitted, and outputs the encoded data to the network interface 401. Also, the communication unit 402 obtains data by decoding a signal received from the network interface 401.

The audio recording unit 403 converts an audio signal received by the communication unit 402 into audio data, and stores the audio data into the storage unit 405.

The text generating unit 404 generates text data from an audio signal received by the communication unit 402, where the text data represents contents of the audio signal. It should be noted here that there is known a technology of generating text data from an audio signal using a voice recognition technology, and thus the process of generating the text data is not described in detail in the present document.

The storage unit 405 is achieved by a memory such as RAM, and stores data for achieving the audio group communication. Especially, the storage unit 405 stores: a member list for managing the participation state of the mobile communication device 100 in the audio group communication; the audio data recorded by the audio recording unit 403; the text data generated by the text generating unit 404; and a conversation list for managing the audio data and the text data in correspondence with each other. The member list and the conversation list will be described in detail later.

The control unit 406 controls the units 401 to 405, and is achieved by, for example, a CPU. The control unit 406 includes a display information transmission processing unit 406a, an audio data transmission processing unit 406b, a member managing unit 406c, and a conversation managing unit 406d. It should be noted here that the units included in the control unit 406 are represented by computer programs.

The display information transmission processing unit 406a instructs the communication unit 402 to transmit text data stored in the storage unit 405 to the mobile communication device 100.

The audio data transmission processing unit 406b instructs the communication unit 402 to transmit audio data stored in the storage unit 405 to the mobile communication device 100.

The member managing unit 406c manages the mobile communication device 100 that participates in the audio group communication, and updates the member list stored in the storage unit 405 depending on the participation of the mobile communication device 100 in the audio group communication.

The conversation managing unit 406d manages the conversation in the audio group communication while the audio group communication is performed. More specifically, the conversation managing unit 406d performs a process of transmitting the audio signal received by the communication unit 402 to mobile communication devices other than the transmission source of the audio signal, instructs the audio recording unit 403 to record the audio signal received by the communication unit 402, and instructs the text generating unit 404 to convert the audio signal received by the communication unit 402 into text data, and updates the conversation list stored in the storage unit 405.

2. Data

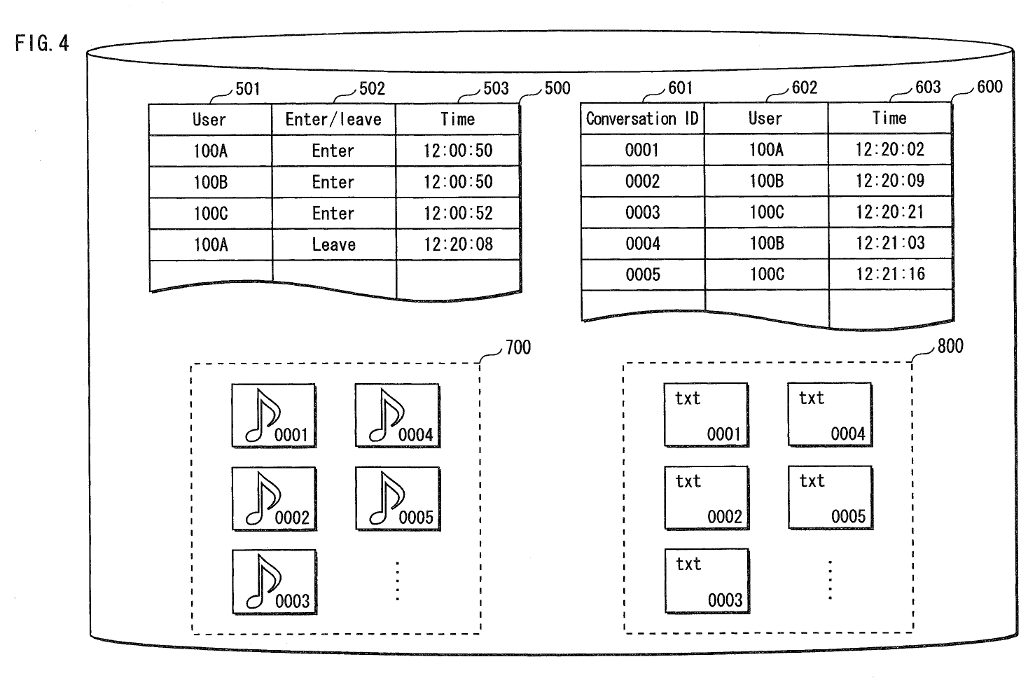

Next, the following will describe, with reference to FIG. 4, the member list, conversation list, audio data, and text data that are stored in the storage unit 405 of the server 400.

FIG. 4 illustrates the data structure inside the storage unit 405.

A member list 500 is used for managing times when each of the mobile communication devices 100A through 100C enters and leaves an audio group communication. The member list 500 is updated by the member managing unit 406c.

A user column 501 indicates mobile communication devices used by corresponding users.

An enter/leave column 502 indicates, in each row of the list, either a communication device entered or leaved an audio group communication.

A time column 503 indicates, in each row of the list, a time when a communication device entered or leaved an audio group communication.

A conversation list 600 is used for managing audio signals (conversations) that are sent from the mobile communication devices 100A through 100C and received by the communication unit 402 during an audio group communication, for each of the mobile communication devices (users). The conversation list 600 is updated by the conversation managing unit 406d.

A conversation ID column 601 indicates conversation IDs each of which is uniquely assigned to a conversation.

A user column 602 indicates, in each row of the list, a mobile communication device used by a user who had a conversation in the audio group communication.

A time column 603 indicates, in each row of the list, a time when a conversation started, namely, a time when the communication unit 402 received a corresponding audio signal.

An audio data storage area 700 stores, in sequence, audio data recorded by the audio recording unit 403 in accordance with an instruction of the conversation managing unit 406d. When each piece of audio data is stored into the audio data storage area 700, it is assigned with a conversation ID that is indicated in the conversation ID column 601.

A text data storage area 800 stores, in sequence, text data generated by the text generating unit 404 in accordance with an instruction of the conversation managing unit 406d. When each piece of text data is stored into the text data storage area 800, it is assigned with a conversation ID that is indicated in the conversation ID column 601, as is the case with the audio data.

3. Operation

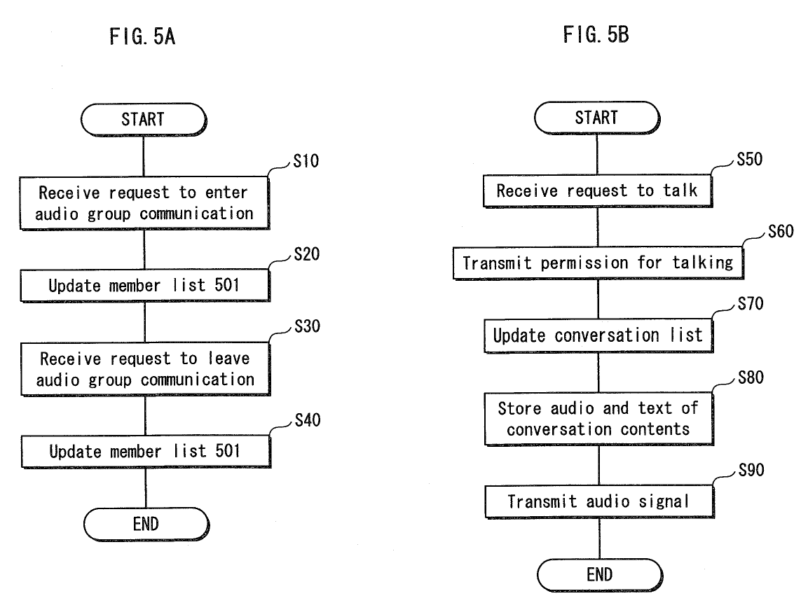

Next, the operation of the mobile communication device 100 and the server 400 will be described with reference to FIGS. 5A through 7.

3-1. Basic Operation of Server

First, basic operations of the server 400 will be described with reference to FIGS. 5A and 5B.

FIG. 5A is a flowchart showing a member management operation that is one of the basic operations performed by the server 400.

When the server 400 receives a request signal that indicates a request to enter an audio group communication, from a mobile communication device 100 that has not entered the audio group communication (step S10), the member managing unit 406c writes an ID (one of “100A” through “100C”) which identifies the mobile communication device 100 that sent the request signal, into the user column 501, writes “enter” (indicating that the mobile communication device 100 entered the audio group communication) into the enter/leave column 502, and writes the time when the mobile communication device 100 entered the audio group communication into the time column 503, thereby updating the member list 500 (step S20).

Also, when the server 400 receives a request signal that indicates a request to leave the audio group communication, from a mobile communication device 100 (step S30), the server 400 writes an ID (one of “100A” through “100C”) which identifies the mobile communication device 100 that sent the request signal, into the user column 501, writes “leave” (indicating that the mobile communication device 100 leaved the audio group communication) into the enter/leave column 502, and writes the time when the mobile communication device 100 leaved the audio group communication into the time column 503, thereby updating the member list 500 (step S40).

The server 400 manages the mobile communication devices that entered and leaved an audio group communication, by performing the steps S10 through S40 described above.

FIG. 5B is a flowchart showing a conversation management operation that is another one of the basic operations performed by the server 400.

When the server 400 receives a request signal that indicates a request to talk, from a mobile communication device 100 participating the audio group communication (step S50), the server 400 transmits a permission for talking to the mobile communication device 100 (step S60).

Then, when the server 400 receives an audio signal that represents contents of a talking by the user of the mobile communication device 100, the server 400 assigns a conversation ID to audio data (conversation) obtained from the received audio signal, writes an ID (one of “100A” through “100C”) identifying the mobile communication device 100 being the transmission source of the audio signal, into the user column 602, and writes the time when the talking started into the time column 603, thereby updating the conversation list 600 (step S70).

A file of audio data is generated by the audio recording unit 403 from the audio signal that was received in step S70, and a corresponding conversation ID is used as a file name of the file, and the audio data is stored in the audio data storage area 700. Also, a file of text data is generated by the text generating unit 404 from the audio signal, and the corresponding conversation ID is used as a file name of the file, and the text data is stored in the text data storage area 800 (step S80).

Further, the audio signal that was received in step S70 is transmitted, via the communication unit 402, to mobile communication devices of participants of the audio group communication other than the talker (step S90).

The server 400 records the conversations, converts the conversations into texts, and serves as an intermediary in transferring the conversations during an audio group communication, by performing the steps S50 through S90 described above.

3-2. Conversation Contents Learning Operation

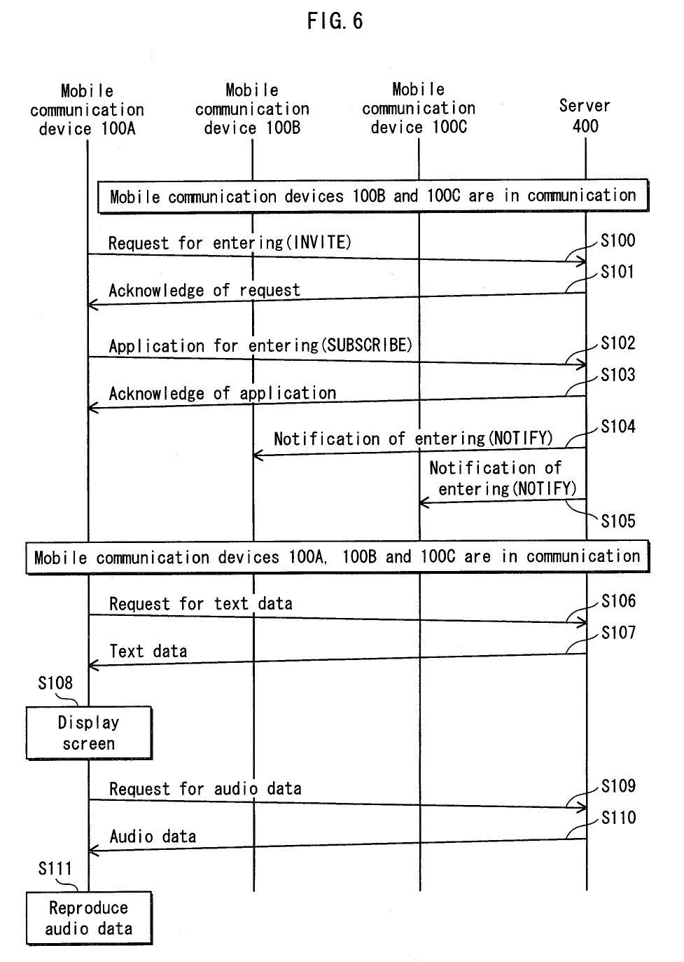

Next, the operation for leaning the contents of conversations having been made in an audio group communication will be described with reference to FIG. 6.

FIG. 6 is a sequence diagram showing the operation of the mobile communication device 100 and the server 400.

Used in the following description is an example case where the mobile communication device 100A newly enters an audio group communication that has been performed between the mobile communication devices 100B and 100C. It is also presumed that the server 400 may perform the steps S10 through S90 whenever a necessity arises.

While an audio group communication is being performed between the mobile communication devices 100B and 100C, the server 400 performs as follows: the control unit 406 serves as an intermediary in transferring audio signals between the mobile communication devices 100B and 100C; the audio recording unit 403 converts received audio signals into audio data and stores the audio data into the audio data storage area 700; the text generating unit 404 generates text data from received audio signals and stores the text data into the text data storage area 800.

Then, during the audio group communication, the user of the mobile communication device 100A operates the operation unit 106, and the audio group communication entering requesting unit 109c requests to the server 400, via the transmission unit 101a, that the mobile communication device 101A enter the audio group communication (step S100).

The server 400 sends an acknowledge signal in response to the entering request from the mobile communication device 100A (step S101). Upon receiving the acknowledge signal, the mobile communication device 100A files an application for entering the audio group communication by transmitting information of the own device to the server 400 (step S102).

The server 400 sends an acknowledge signal in response to the application for entering, to the mobile communication device 100A (step S103), and transmits, to the mobile communication devices 100B and 100C, a notification signal notifying that the mobile communication device 100A has newly entered the audio group communication (steps S104 and S105).

After the mobile communication device 100A enters the audio group communication, the display information requesting unit 109a requests text data to the server 400 via the transmission unit 101a (step S106).

Upon receiving the request for the text data from the mobile communication device 10A, the server 400 performs as follows: the audio data transmission processing unit 406b refers to the member list 500 and the conversation list 600 stored in the storage unit 405, and transmits, to the mobile communication device 100A, information contained in the lists, as well as the text data stored in the text data storage area 800 (step S107).

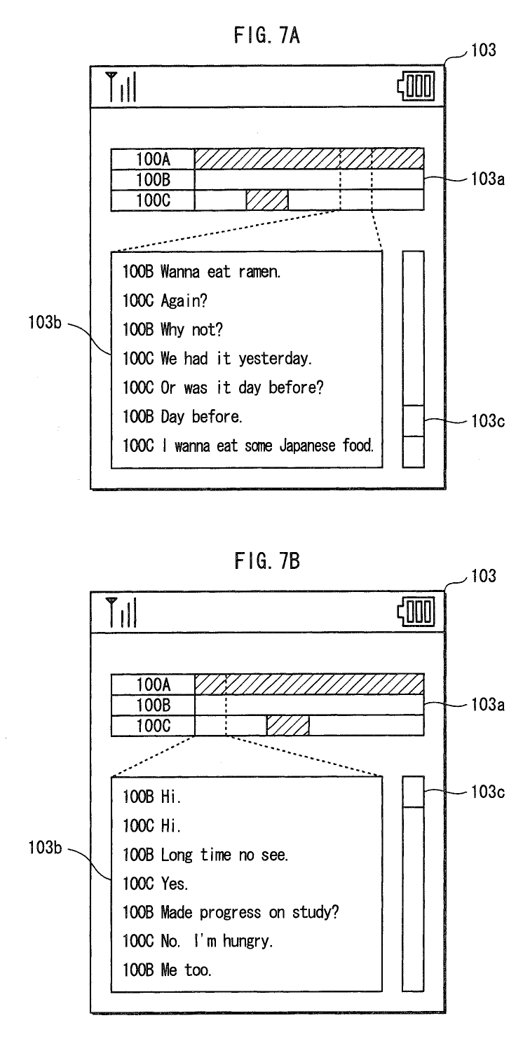

The mobile communication device 100A displays the text data received from the server 400, onto the display unit 103 (step S108). FIGS. 7A and 7B show examples of a screen displayed at this point in time.

As shown in FIGS. 7A and 7B, the screen displayed on the display unit 103 at this point in time includes a graph 103a indicating an elapsed time from the start of the audio group communication performed by the mobile communication devices 100B and 100C, a text field 103b displaying text data, and a cursor 103c. In the graph 103a, periods during which any mobile communication devices had left the audio group communication are indicated by slant lines. The user can display the text data of a desired time period by moving the cursor 103c with operation on the operation unit 106, where the text data shows the contents of conversations that were made during the time period. For example, the displayed text data can be switched from the one shown in FIG. 7A to the one shown in FIG. 7B.

When the user selects a desired piece of text data by performing an operation on the operation unit 106 while the display unit 103 is displayed, the audio data requesting unit 109b requests, to the server 400 via the transmission unit 101a, audio data that corresponds to the selected piece of text data (step S109).

Upon receiving the request for audio data, the server 400 refers to the conversation list 600 in the storage unit 405, identifies a piece of audio data having a conversation ID that corresponds to the selected piece of text data, from among the audio data stored in the audio data storage area 700, and transmits the identified piece of audio data to the mobile communication device 100A (step S110).

In the mobile communication device 100A having received the audio data from the server 400, the reproduction unit 108 reproduces the received audio data (step S111).

With the above-described operation, when the user enters the audio group communication, the user can learn the contents of conversations that had been made between other users while the user had not participated the audio group communication, by reading the text data displayed on the screen.

Furthermore, the user can specify a part of the text data so that the user can confirm, by listening, whether or not the contents of the specified part are correct. This function is useful, for example, when the audio signal had not been converted correctly into the text due to the immaturity of the voice recognition technology that was actually adopted and thus incomprehensible characters were displayed.

With the above-described structure, the mobile communication device 100 first receives text data, which is generally smaller in amount than audio data. This can reduce the load on the network 300, compared with the case where a large amount of audio data is transmitted at once.

### Embodiment 2

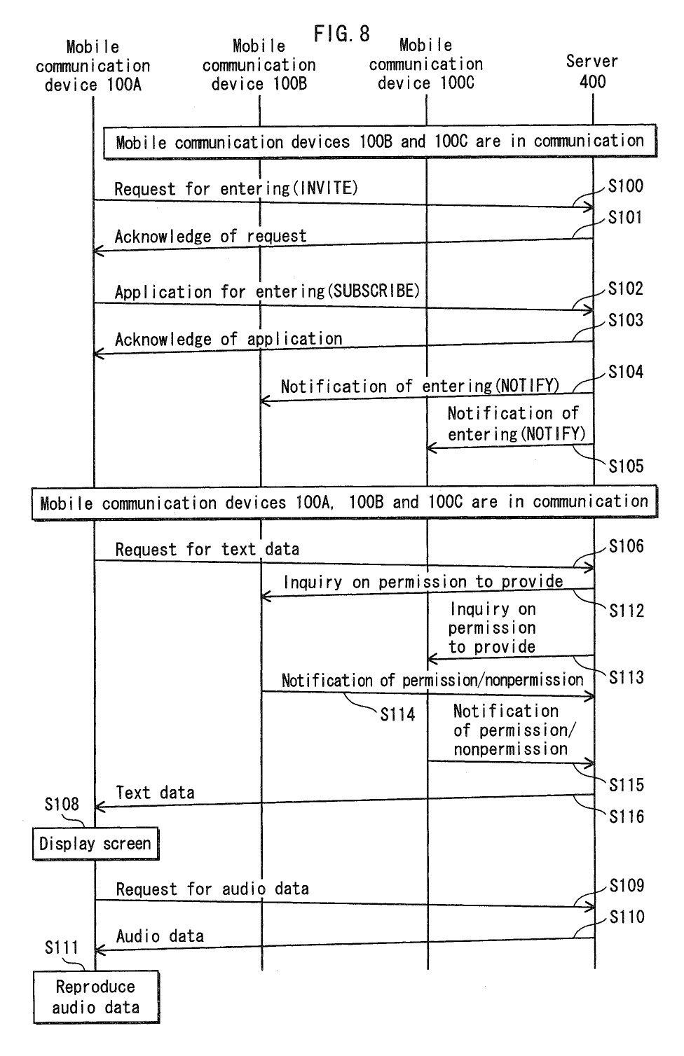

Next, a communication system and a mobile communication device in the second embodiment will be described with reference to FIG. 8.

In Embodiment 1, when a mobile communication device 100 requests text data to the server 400 (step S106), the server 400 unconditionally sends the text data stored in the storage unit 405 to the mobile communication device 100 (step S107). Compared with this, in Embodiment 2, the server 400 does not send the text data unless the other mobile communication devices participating in the audio group communication permit to provide it.

In the following, only differences from Embodiment 1 will be described in detail.

1. Structure

1-1. Structure of Mobile Communication Device

The audio group communication processing unit 109d generates a signal that indicates whether or not it permits transmitting text data to another mobile communication device 100, in accordance with an operation by the user, and transmits the generated signal to the transmission unit 101a.

1-2. Structure of Server

The display information transmission processing unit 406a instructs the communication unit 402 to transmit, to the mobile communication device(s) 100, an inquiry signal that asks the device(s) whether or not the device(s) permits transmitting text data. The display information transmission processing unit 406a also selects text data to be transmitted, from among the text data stored in the storage unit 405, in accordance with answers to the inquiry received from the mobile communication device(s) 100.

2. Operation

Next, the operation of the mobile communication device 100 and the server 400 will be described with reference to FIG. 8.

FIG. 8 is a sequence diagram showing the operation of the mobile communication device 100 and the server 400. It should benoted here that the operation (shown in FIG. 6) that has already been described in Embodiment 1 is not described here.

After the mobile communication device 100A newly enters an audio group communication (steps S100 through S105), when the server 400 receives a request for text data from the mobile communication device 10A (step S106), the server 400 transmits, to the mobile communication devices 100B and 100C, an inquiry signal that asks the devices whether or not the devices permit transmitting text data to the mobile communication device 101A (steps S112, S113).

Each of the mobile communication devices 100B and 100C generates a notification that indicates whether or not it permits transmitting text data to the mobile communication device 100A, in accordance with an operation by the user onto the operation unit 106, and transmits the generated notification to the server 400 (steps S114, S115).

The server 400 refers to the user column 602 in the conversation list 600, and selects, from among the text data stored in the storage unit 405, one or more pieces of text data to be transmitted, which correspond to mobile communication device(s) (100B and/or 100C) that permitted transmitting text data to the mobile communication device 100A, and transmits the selected piece(s) of text data to the mobile communication device 101A (step S116).

With the above-described operation, even if a user of the mobile communication device 100A, who newly entered an audio group communication in the middle thereof, requests text data of the conversations that were made before the user entered, only text data that was permitted by any of the mobile communication devices 100B and 100C is transmitted to the mobile communication device 100A. With this structure, for example, when the mobile communication devices 100B and 100C had talked about a subject which is desired to be kept secret from the user of the mobile communication device 100A, users of the mobile communication devices 100B and 100C can prevent the text data from being transmitted to the mobile communication device 100A.

### Embodiment 3

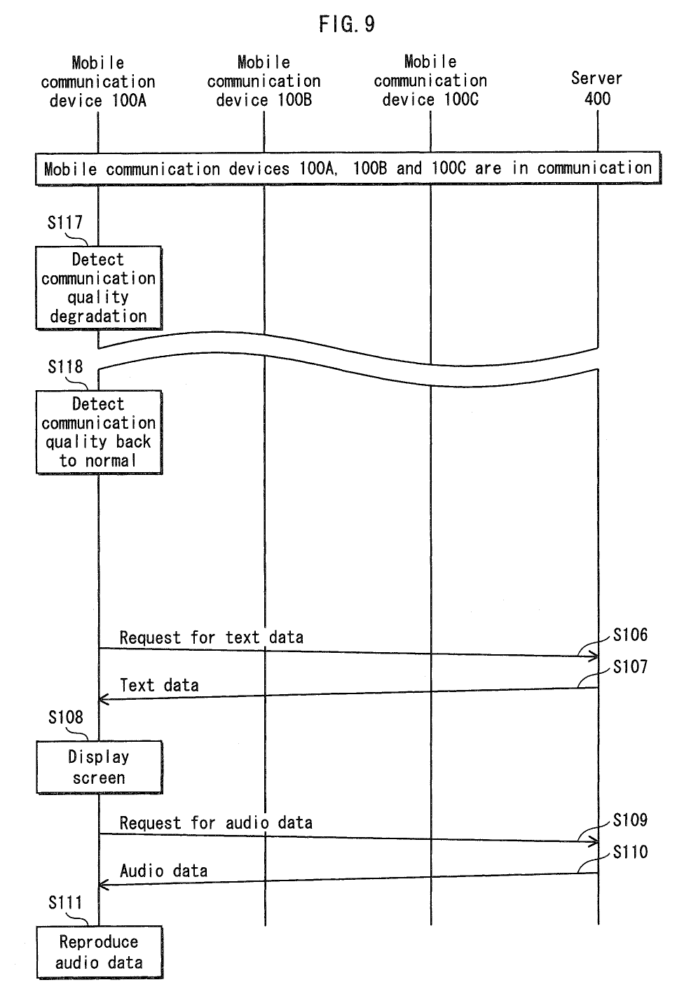

Next, a communication system and a mobile communication device in the third embodiment will be described with reference to FIG. 9.

In Embodiment 1, a mobile communication device 100 requests text data (step S106) after it enters an audio group communication (steps S100 through S105). Compared with this, in Embodiment 3, when the communication quality is degraded, a mobile communication device 100 requests text data after the communication quality is recovered.

In the following, only differences from Embodiment 1 will be described in detail.

1. Operation

The operation of the mobile communication device 100 and the server 400 will be described with reference to FIG. 9.

FIG. 9 is a sequence diagram showing the operation of the mobile communication device 100 and the server 400. It should be noted here that the operation (shown in FIG. 6) that has already been described in Embodiment 1 is not described here.

First, while the mobile communication devices 100A, 100B and 100C are in communication, the communication quality detecting unit 109f detects that the communication quality has dropped below a predetermined level (step S117).

After this, when the communication quality detecting unit 109f detects that the communication quality has returned to a level equal to or larger than the predetermined level (step S118), the display information requesting unit 109a requests text data to the server 400 via the transmission unit 101a (step S106). The step is followed by the same steps as in Embodiment 1 (steps S107-S111).

There may be the case where a conversation is interrupted due to degradation of the communication quality during an audio group communication. However, in such a case, the above-described operation enables the user to, by reading the text data, confirm the contents of the conversation that was made between other users while the user was suffered by the communication quality degradation and could not participate in the conversation.

### Embodiment 4

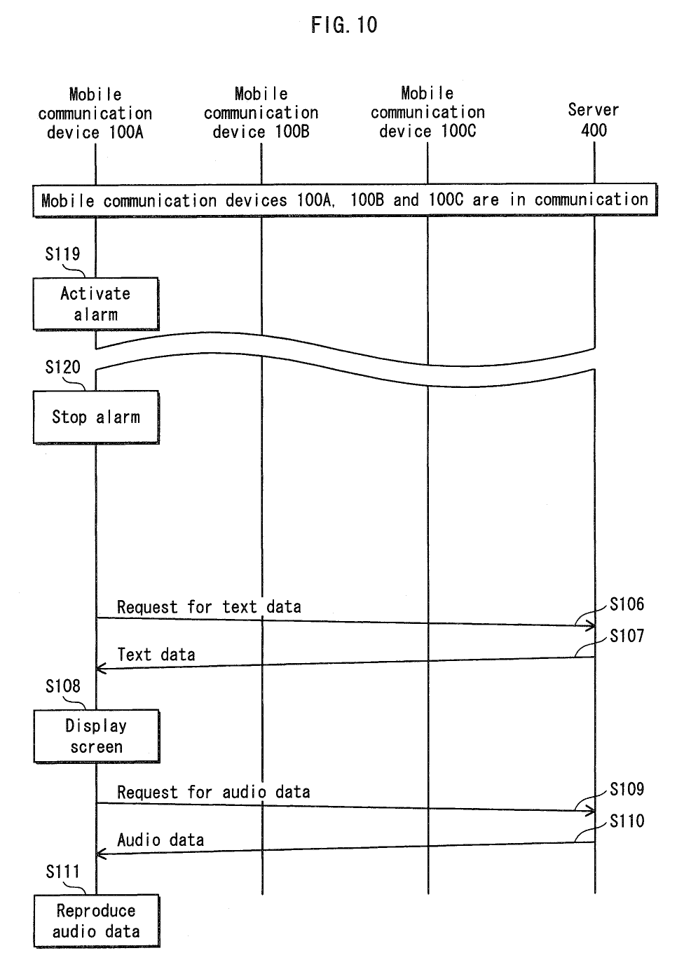

Next, a communication system and a mobile communication device in the fourth embodiment will be described with reference to FIG. 10.

In Embodiment 1, a mobile communication device 100 requests text data (step S106) after it enters an audio group communication (steps S100 through S105). Compared with this, in Embodiment 4, a mobile communication device 100 requests text data after an application, which may interrupt the audio group communication, is activated and ended.

In the following, only differences from Embodiment 1 will be described in detail.

1. Operation

The operation of the mobile communication device 100 and the server 400 will be described with reference to FIG. 10.

FIG. 10 is a sequence diagram showing the operation of the mobile communication device 100 and the server 400. It should be noted here that the operation (shown in FIG. 6) that has already been described in Embodiment 1 is not described here.

First, while the mobile communication devices 100A, 100B and 100C are in communication, the alarm application executing unit 109e starts to execute an application for outputting an alarm sound when a preliminarily set alarm time is reached (step S119).

After this, the alarm application executing unit 109e ends the application (i) in accordance with an operation by the user performed onto the operation unit 106, or (ii) when a preliminarily set alarm period has elapsed (step S120). Then, the display information requesting unit 109a requests text data to the server 400 via the transmission unit 101a (step S106). The step is followed by the same steps as in Embodiment 1 (steps S107-S111).

There may be the case where a conversation is interrupted by an alarm sound that drowns out the voice of the communication partner (the mobile communication devices 100B and 100C). However, in such a case, the above-described operation enables the user to, by reading the text data after the alarm sound ends, confirm the contents of the conversation that was made between other users while the user was suffered by the alarm sound and could not participate in the conversation.

### <Variations>

Up to now, the communication system and mobile communication device of the present invention have been described through Embodiments 1 to 4. However, not limited to Embodiments 1 to 4, the present invention can be varied in various ways in terms of the structures and operations described in these embodiments.

(1) In Embodiment 1, upon receiving a request from a mobile communication device 100, the server 400 transmits all text data stored in the text data storage area 800 to the mobile communication device being the request source (step S107). However, not limited to this, the server 400 may transmit only a set of text data that corresponds to contents of conversations that were made while the mobile communication device 100 did not participate the audio group communication.

In this case, in the server 400, the audio data transmission processing unit 406b identifies a time period during which the mobile communication device, the request source of the request for text data, did not participate the audio group communication, by referring to the member list 500, then identifies a set of text data corresponding to contents of conversations that were made during the identified time period, by referring to the conversation list 600, and transmits the identified set of text data to the request source.

For example, in the case of the operation in Embodiment 1 shown in FIG. 6, in step S107, the audio data transmission processing unit 406b identifies a time period during which the mobile communication device 100A did not participate the audio group communication, by referring to the member list 500, then identifies a set of text data corresponding to contents of conversations that were made during the identified time period, by referring to the conversation list 600, retrieves the identified set of text data from the text data storage area 800, and transmits the retrieved set of text data to the mobile communication device 100A.

With this arrangement, the user needs not search the text data displayed on the screen (step S108) for a desired set of text data by scrolling it, but can immediately confirm the contents of conversation that were made during the time period during which the user did not participate the audio group communication.

(2) In Embodiment 1, upon receiving a request from a mobile communication device 100, the server 400 transmits all text data stored in the text data storage area 800 to the mobile communication device being the request source (step S107), and upon receiving this, the mobile communication device 100 displays all the received text data. However, not limited to this, the mobile communication device 100 may display only a set of text data that corresponds to contents of conversations that were made while the mobile communication device 100 did not participate the audio group communication.

To achieve this, in the server 400, the audio data transmission processing unit 406b instructs the communication unit 402 to transmit the member list 500 and the conversation list 600 to the mobile communication device 100, as well as the text data.

Also, in the mobile communication device 100, the control unit 109 identifies a time period during which the mobile communication device 100, that requested the text data, did not participate the audio group communication, by referring to the member list 500 received from the server 400, then identifies a set of text data corresponding to contents of conversations that were made during the identified time period, by referring to the conversation list 600, and displays the identified set of text data.

For example, in the case of the operation in Embodiment 1 shown in FIG. 6, in step S107, the audio data transmission processing unit 406b transmits the member list 500 and the conversation list 600 as well as the text data to the request source of the text data.

In step S108, the mobile communication device 100A identifies a time period during which the mobile communication device 100A did not participate the audio group communication, by referring to the member list 500, then identifies a set of text data corresponding to contents of conversations that were made during the identified time period, by referring to the conversation list 600, and displays only the identified set of text data onto the display unit 103.

With this arrangement, the user needs not search the text data displayed on the screen (step S108) for a desired set of text data by scrolling it, but can immediately confirm the contents of conversation that were made during the time period during which the user did not participate the audio group communication.

(3) In Embodiment 1, audio data is recorded in units of statements uttered by the users (of the mobile communication devices 100A through 100C), text data is generated in association with the recorded audio data. However, the present invention is not limited to this.

For example, the server 400 may start to record a block of audio data and generate a corresponding block of text data each time a mobile communication device 100 enters or leave the audio group communication.

In this case, the conversation managing unit 406d starts to record a block of audio data and generate a corresponding block of text data by assigning a new conversation ID to the blocks of audio data and text data, when a mobile communication device 100 newly enters the audio group communication, and also starts to record a block of audio data and generate a corresponding block of text data by assigning a new conversation ID to the blocks of audio data and text data, when a mobile communication device 100 leaves the audio group communication.

With this arrangement, it is possible to reduce the number of pieces of audio data and text data generated by the server 400.

(4) In Embodiment 2, in response to an inquiry from the server 400 (steps S112, S113), the mobile communication device 100 transmits a notification that indicates whether or not it permits transmitting text data, which corresponds to all the statements that a user of the device made, to the mobile communication device 100A (steps S114, S115). However, not limited to this, the mobile communication device 100 may transmit the notification indicating, for each statement, whether or not to permit transmitting text data.

In this case, in the server 400, the display information transmission processing unit 406a identifies text data that corresponds to statements uttered by the user of the mobile communication device 100, a transmission destination of the text data, by referring to the conversation list 600, and instructs the communication unit 402 to transmit the identified text data to the transmission destination, as well as an inquiry signal that asks the device whether or not the device permits transmitting the identified text data. The display information transmission processing unit 406a also selects text data to be transmitted, from among the text data stored in the text data storage area 800, in accordance with answers to the inquiry received from the mobile communication device 100, and transmits the selected text data to the request source.

Also, in the mobile communication device 100, the display unit 103 displays the received text data, the operation unit 106 receives an operation that selects desired text data in units of statements from among the displayed text data, and the audio group communication processing unit 109d generates a signal indicating that the selected text data be transmitted to another mobile communication device 100, and outputs the generated signal to the transmission unit 101a.

For example, in the case of the operation in Embodiment 2 shown in FIG. 8, in step S112, the audio data transmission processing unit 406b transmits text data corresponding to the statements that were made by the user of the mobile communication device 100B, as well as an inquiry signal. Similarly, in step S113, the audio data transmission processing unit 406b transmits text data corresponding to the statements that were made by the user of the mobile communication device 100C, as well as an inquiry signal.

Then, in step S114, the mobile communication device 100B generates a notification that indicates text data corresponding to statements of the user thereof that are permitted to be transmitted to the mobile communication device 100A, and transmits the generated notification to the server 400. Similarly, in step S115, the mobile communication device 100C generates a notification that indicates text data corresponding to statements of the user thereof that are permitted to be transmitted to the mobile communication device 100A, and transmits the generated notification to the server 400.

In step S116, the server 400 selects only text data that is indicated by the notifications that were transmitted in steps S115 and S116, and transmits the selected text data to the mobile communication device 100A.

With this arrangement, each user can determine whether or not to permit text data to be transmitted to another mobile communication device, for each statement he/she has made. This is effective, for example, when the user made a statement that the user does not want to be known to the other user.

### <Supplementary Notes>

(1) In Embodiments 1 through 4, the text generating unit 404 may generate text data that is easier for users to understand the contents of conversations.

For example, the text generating unit 404 may generate text data in which the fonts of the characters are modified depending on the amount of voice in the audio signal. More specifically, the text generating unit 404 may generate text data with large fonts for a statement uttered with large voice, and generate text data with small fonts for a statement uttered with small voice.

As another example, the text generating unit 404 may add question mark “?” or exclamation mark “!” to the text data depending on the tone of the audio signal.

(2) In Embodiments 1 through 4, PTT (Push To Talk) is used as one example of the audio group communication. However, not limited to this, the present invention is applicable to various communication forms, such as a television conference performed on mobile communication devices, in which a group communication is performed among a plurality of members via a server.

(3) In Embodiments 1 through 4, text data generated by the text generating unit 404 is used as the display information. However, not limited to this, any thing that enables the user to visually confirm the contents of conversations may be displayed. For example, certain key words may be detected from the conversations, and images (icons) that indicate the keywords may be generated.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A mobile communication device for performing communications with a plurality of mobile communication devices via a server storing audio data transmitted from the plurality of mobile communication devices and display information associated with the audio data, the mobile communication device comprising:
a display information requesting unit operable to request a set of display information to the server;
a display information receiving unit operable to receive the requested display information from the server; and
a display unit operable to display the received display information.

2. The mobile communication device of claim 1 further comprising
an operation detecting unit operable to detect an operation of specifying the set of display information to be requested, wherein
the display information requesting unit requests, to the server, the set of display information specified by the operation detected by the operation detecting unit.

3. The mobile communication device of claim 1 further comprising
an audio data requesting unit operable to request, to the server, a set of audio data in relation to the set of display information displayed by the display unit;
an audio data receiving unit operable to receive the requested set of audio data from the server; and
a reproduction unit operable to reproduce the received set of audio data.

4. The mobile communication device of claim 2 further comprising
an audio data requesting unit operable to request, to the server, a set of audio data in relation to the set of display information displayed by the display unit;
an audio data receiving unit operable to receive the requested set of audio data from the server; and
a reproduction unit operable to reproduce the received set of audio data.

5. The mobile communication device of claim 4, wherein
the operation detecting unit further detects another operation performed to specify a piece of display information from among the set of display information displayed by the display unit, and
the audio data requesting unit requests, to the server, a piece of audio data in relation to the piece of display information specified by the other operation detected by the operation detecting unit.

6. The mobile communication device of claim 5, wherein
the server stores audio data of each statement uttered by users of the plurality of mobile communication devices and stores display information associated with the audio data,
the display unit displays the display information for each statement of the users, and
the operation detecting unit detects an operation performed to specify a piece of display information in association with a desired statement uttered by a user from among the display information displayed by the display unit.

7. The mobile communication device of claim 5, wherein
the server includes a text data generating unit operable to generate text data from audio,
the server stores the generated text data as the display information,
the display information requesting unit requests the text data as the display information,
the display unit displays text data received from the server,
the operation detecting unit detects an operation performed to specify a piece of text data from among the text data displayed by the display unit, and
the audio data requesting unit transmits, to the server, a signal requesting a piece of audio data in relation to the specified piece of text data.

8. The mobile communication device of claim 1 further comprising
a communication entering requesting unit operable to transmit a request for entering a communication to the server, wherein
the server manages, in a time series based on the request for entering, a state in which a user of the mobile communication device participates in the communication, and
the display information displayed by the display unit is the set of display information received from the server, the set of display information being associated with a set of audio data that is contents of statements uttered in a time period during which the user did not participate in the communication.

9. The mobile communication device of claim 1 further comprising
a communication entering requesting unit operable to transmit a request for entering a communication to the server, wherein
the display information requesting unit requests the set of display information to the server when the communication entering requesting unit transmits the request for entering the communication to the server.

10. The mobile communication device of claim 1 further comprising
an executing unit operable to execute a program that controls to output a sound independently from the communications, wherein
the display information requesting unit requests the display information when the executing unit ends executing the program.

11. The mobile communication device of claim 1 further comprising
a quality detecting unit operable to detect communication quality of the communications, wherein
the display information requesting unit requests the display information when the quality detecting unit detects that the communication quality has dropped below a predetermined level and then detects that the communication quality has returned to a level equal to or larger than the predetermined level.

12. A communication system comprising a server and a plurality of mobile communication devices which perform communications with each other via the server,
the server including:
an audio data storage unit operable to store audio data transmitted from the plurality of mobile communication devices;
a display information storage unit operable to store display information in association with the audio data; and
a display information transmitting unit operable to transmit the display information to the plurality of mobile communication devices, in accordance with requests received from the plurality of mobile communication devices, and
each of the plurality of mobile communication devices includes:
a display information requesting unit operable to request the display information to the server;
a display information receiving unit operable to receive the requested display information from the server; and
a display unit operable to display the received display, information.

13. The communication system of claim 12, wherein
the server further includes
an inquiring unit operable to, when one of the plurality of mobile communication devices requests for a set of display information, inquire remaining ones of the plurality of mobile communication devices whether or not to permit transmitting the requested set of display information to the mobile communication device being a requester, wherein
the display information transmitting unit transmits the requested set of display information to the requester only when the server receives, from the remaining ones of the plurality of mobile communication devices, notifications that permit transmitting the requested set of display information to the requester.

14. A communication method for a mobile communication device for performing communications with a plurality of mobile communication devices via a server storing audio data transmitted from the plurality of mobile communication devices and display information associated with the audio data, the communication method comprising the steps of:
requesting a set of display information to the server;
receiving the requested display information from the server; and
displaying the received display information.
